(19) United States
(12) Patent Application Publication
(10) Pub. No.: US 2008/0134779 A1
(43) Pub. Date: Jun. 12, 2008

(54) SOLUTION METERING APPARATUS

(76) Inventors: CHUN-CHIN TUNG, Chupei (TW); Yung-Lieh Chien, Chupei (TW)

Correspondence Address: G. LINK CO., LTD., 3550 BELL ROAD, MINOOKA, IL, 60447, US

(21) Appl. No.: 11/954,231

(22) Filed: Dec. 12, 2007

(30) Foreign Application Priority Data
Dec. 12, 2006 (TW) 095221901

(51) Int. Cl. G01F 23/26

(52) U.S. Cl. 73/304 C

(57) ABSTRACT

A solution metering apparatus used in a solution storage vessel for measuring the height of solution comprises a substrate; a sensor layer consisting of a first sensing member and a second sensing member where the first sensing member and the second sensing member respectively have, in horizontal direction, a plurality of sidewardly extended parallel strip lines that are alternately arranged, and the sensor layer is disposed on one side surface of the substrate; a protective layer overlying the sensor layer to determine the height of the fluid in the vessel based on the physical characteristics of the fluid as detected by the sensor layer, particularly its capacitance characteristics, and then determine whether to feed more fluid into the vessel.

### FIELD OF THE INVENTION

The present invention relates to a solution metering apparatus, more particularly a metering apparatus for measuring the fluid level in a solution storage vessel.

### BACKGROUND OF THE INVENTION

Conventional fluid level measuring devices measure the fluid quantity. Fluid measuring devices are generally sizable and complex in structure, and hence more costly. However there is increasingly market demand for small-size and low-cost products. Take the example of fuel cell system, its applications in portable electronic devices are picking up. In a fuel cell system that uses hydrogen-rich fuel (e.g. methanol) and oxygen fuel to undergo electrochemical reaction and output power, it is necessary for users to know when to replenish the fuel when fluid concentration or level becomes low. Thus it is necessary to detect the fluid fuel level and volume in the fuel container. Such detection work is typically achieved through expensive metering sensor, which is rather uneconomical when used extensively in portable electrical products.

In light of the drawbacks of conventional fluid measuring devices, the inventor with many years of experience in the industry aims to develop an improved fluid measuring device that effectively achieves the objects.

### SUMMARY OF THE INVENTION

The primary object of the invention is to provide a solution metering apparatus for measuring the fluid level or other physical characteristics of fluid in a solution storage vessel that also has a structure able to protect the circuitry of the metering apparatus.

Another object of the invention is to provide a solution metering apparatus that uses its sensing member to measure capacitance, inductance, impedance or any electric signal in the combination of such signals to obtain corresponding physical characteristics of the solution.

Yet another object of the invention is to provide a solution metering apparatus that can be used in a fuel cell system for measuring the fluid fuel level in the fuel storage vessel of the fuel cell.

A further object of the invention is to provide a solution metering apparatus used in measuring the solution level in a solution storage vessel and comprising a substrate; a sensor layer consisting of a first sensing member and a second sensing member where the first sensing member and the second sensing member respectively have, in horizontal direction, a plurality of sidewardly extended strip lines that are alternately arranged, and the sensor layer is disposed on one side surface of the substrate; a protective layer overlying the sensor layer to determine the height of the fluid in the vessel based on the physical characteristics of the fluid as detected by the sensor layer, particularly its capacitance characteristics, and then determine whether to feed more fluid into the vessel.

The objects, features and effects of the invention are described in detail below with embodiments in reference to the accompanying drawings.

### BRIEF DESCRIPTION OF THE DRAWINGS

FIG. 1 is a partial sectional view of the invention;

FIG. 2 is a partial plane view of the sensor layer of the invention;

FIG. 3 is a diagram of a preferred embodiment of the invention; and

FIG. 4 is a side sectional view of another embodiment of the solution metering apparatus according to the invention.

### DETAILED DESCRIPTION OF THE INVENTION

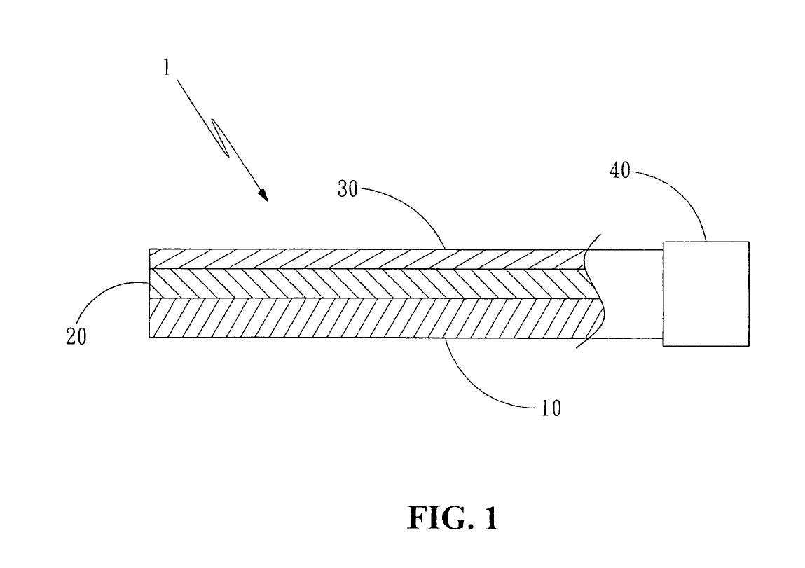

FIG. 1 is partial sectional view of the invention. As shown, the invention provides a solution metering apparatus 1, comprising at least a substrate 10, a sensor layer 20 and a protective layer 30, wherein the sensor layer 20 is sandwiched between the substrate 10 and the protective layer 30, and a connector 40 is disposed at one end of the solution metering apparatus 1 such that the physical quantity measured by the sensor layer 20 can be sent to a microprocessor through the connector 40 or an external electrical apparatus, such as a computer.

The protective layer 30 envelops the entire substrate 10 and the outer surface of the sensor layer 20.

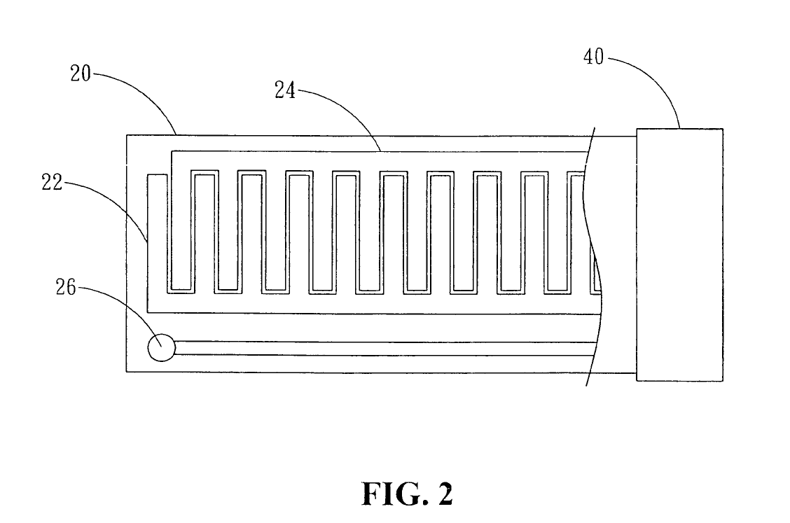

FIG. 2 is a partial plane view of the sensor layer of the invention. As shown, the sensor layer 20 consists of a first sensing member 22 and a second sensing member 24, wherein the first sensing member 22 and the second sensing member 24 respectively have, in horizontal direction, a plurality of sidewardly extended parallel strip lines that are alternately arranged. The sensor layer 20 also comprises a temperature sensor 26. The implementation of the invention is described in detail below.

The plurality of sidewardly extended strip lines in the horizontal direction of the first sensing member 22 and the second sensing member 24 are not necessarily parallel strip lines, so long as they produce capacitance effect.

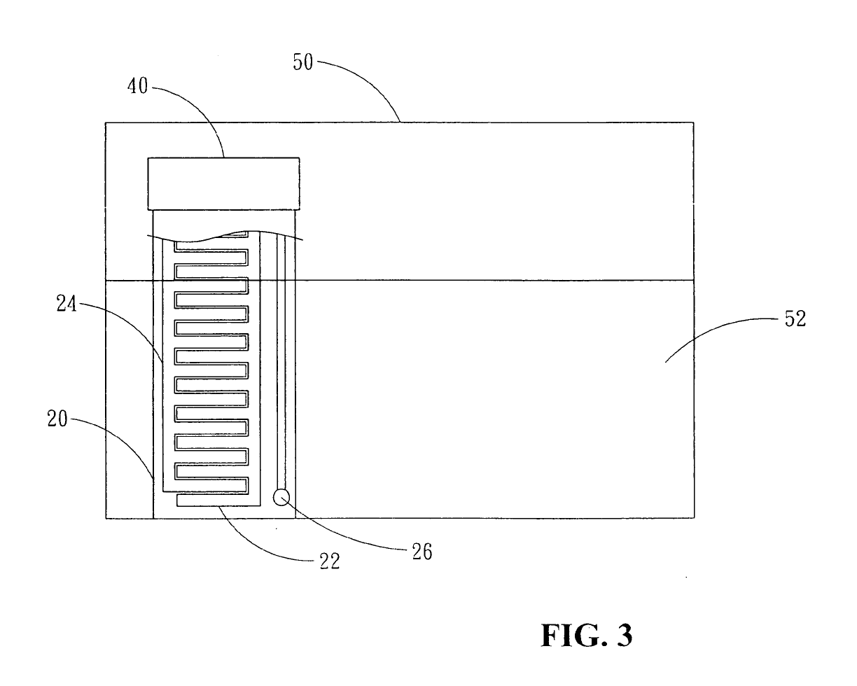

FIG. 3 is a diagram of a preferred embodiment of the invention. As shown, the solution metering apparatus 1 is disposed in a solution storage vessel 50. For example, the solution storage vessel 50 is a fuel storage vessel for storing fuel used in a fuel cell system. The solution storage vessel 50 contains solution 52, while the solution metering apparatus 1 is placed in the depth measuring space therein for measuring the height, density, concentration or other characteristics of the solution, and sends the message received through the connector 40. When the temperature in the solution storage vessel 50 changes, the temperature sensor 26 detects the change and sends out the message through the connector 40 so as to take possible measuring error brought about by temperature change into consideration.

The material for the substrate 10 and the protective layer 30 may be glass fiber (FR4, FR5), epoxy resin, glass fiber laminate, ceramic laminate, polymer laminate or their mixtures thereof to give the substrate 10 and the protective layer 30 corrosion resistance so as to protect the metal material in the sensor layer 20 from corrosive fluid. In addition, the aforementioned materials are materials commonly used in the industry and their processes are mature for easy manufacture of the substrate 10 and the protective layer 30.

The material for the protective layer 30 of solution metering apparatus 1 used in the fuel storage vessel takes into account in avoid of possible corrosion of the lead wire of electric circuit by the fuel. Thus the material for the protective layer 30 can be selected further from Teflon, polyethylene and non-polar material, in which Teflon can be coated onto the outer surface of protective layer 30 and substrate 10 by way of surface coating. The entire outer surface of the solution metering apparatus can also be coated with Teflon.

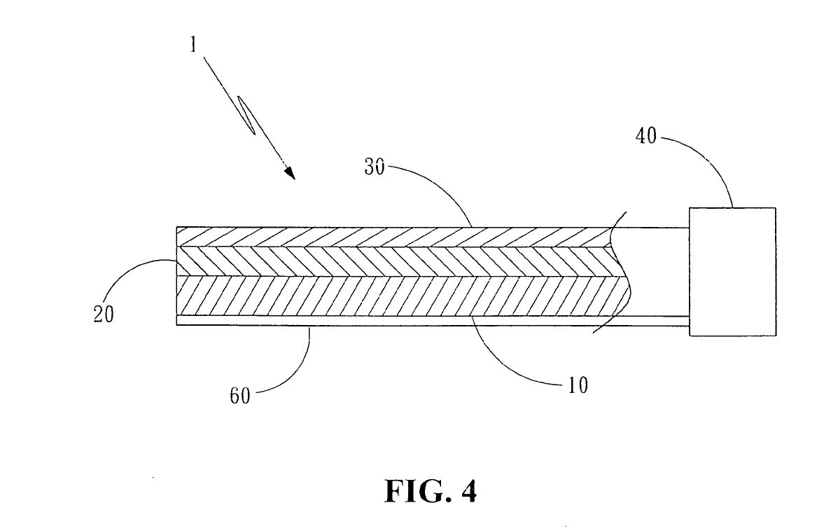

FIG. 4 is a side sectional view of another embodiment of the solution metering apparatus according to the invention. As shown. the solution metering apparatus 1 further comprises a shield layer 60, the shield layer 60 being a metal conductive layer and electrically grounded, and arranged on another side surface of the substrate 10 opposing the sensor layer 20 such that the shield layer 60 can provide an electromagnetic shield when there is any electric element in the vicinity of the solution metering apparatus 1 that might produce electromagnetic interference.

As such, the solution metering apparatus provided by the invention can accurately measure the quantity of solution in a solution storage vessel, including the quantity of the fuel solution in the fuel storage vessel of a fuel cell. The invention possesses inventive step and meets the essential criteria for patent.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A solution metering apparatus, comprising:
a substrate;
a sensor layer, consisting of a first sensing member and a second sensing member, wherein the first sensing member and the second sensing member respectively have in horizontal direction a plurality of sidewardly extended parallel strip lines that are alternately arranged and form capacitance effect, and the sensor layer is disposed on one side surface of the substrate; and
a protective layer overlying the sensor layer.

2. The solution metering apparatus according to claim 1, wherein the sensor layer measures any of the following signals: capacitance, inductance, and impedance.

3. The solution metering apparatus according to claim 1, further comprising a connector, the connector linking the signal generated by the first sensing member and the second sensing member to the exterior.

4. The solution metering apparatus according to claim 3, further comprising a temperature sensor, the signals from the temperature sensor being electrically connected to the connector.

5. The solution metering apparatus according to claim 1, wherein the protective layer envelops the entire substrate and the outer surface of sensor layer.

6. The solution metering apparatus according to claim 1, wherein the material for the substrate is selected from the group consisting of glass fiber, epoxy resin, glass fiber laminate, ceramic laminate, polymer laminate, and mixtures thereof.

7. The solution metering apparatus according to claim 1, wherein the material for the protective layer is selected from the group consisting of glass fiber, epoxy resin, glass fiber laminate, ceramic laminate, polymer laminate, and mixtures thereof.

8. The solution metering apparatus according to claim 1, wherein the material for the protective layer is selected from a group consisting of Teflon, polyethylene, non-polar material and mixtures thereof.

9. The solution metering apparatus according to claim 1, further comprising a shield layer, the shield layer being a metal conductive layer and electrically grounded, and disposed on another side surface of the substrate opposing the sensor layer.

10. The solution metering apparatus according to claim 9, wherein the protective layer envelops the entire substrate and the outer surface of the sensor layer.

11. The solution metering apparatus according to claim 9, wherein the material for the substrate is selected from the group consisting of glass fiber, epoxy resin, glass fiber laminate, ceramic laminate, polymer laminate, and mixtures thereof.

12. The solution metering apparatus according to claim 9, wherein the material for the protective layer is selected from the group consisting of glass fiber, epoxy resin, glass fiber laminate, ceramic laminate, polymer laminate, and mixtures thereof.
